(19) United States
(12) Patent Application Publication
(10) Pub. No.: US 2018/0234381 A1
(43) Pub. Date: Aug. 16, 2018

(54) NETWORK-BASED CALENDARING

(71) Applicant: Facepay, Inc., San Jose, CA (US)

(72) Inventor: Mark Hale, San Jose, CA (US)

(21) Appl. No.: 15/894,352

(22) Filed: Feb. 12, 2018

Related U.S. Application Data
(60) Provisional application No. 62/458,679, filed on Feb. 14, 2017.

(51) Int. Cl. H04L 12/58; G06F 3/0484; G06Q 10/10

(52) U.S. Cl. CPC H04L 51/32; H04L 67/02; G06Q 10/1095; G06F 3/04847

(57) ABSTRACT

Systems and methods are provided for network-based implementation of a calendaring application. A social calendaring application may be implemented amongst users of one or more messaging platforms, such as chat-based text messaging, by a calendar application server. Calendar event configuration, viewing and invitation response mechanisms may be presented to each user on a user device via a web-based user interface. An event may be represented and transmitted within a chat application as a URL, directed to or associated with the calendar application server. A chat application user may select the URL, whereby the calendar server may identify the responding user and present, inter alia, a web-based user interface enabling, e.g., viewing of an event associated with the URL, acceptance of an event invitation, contribution of content to a shared event, viewing of content associated with a shared event, and/or viewing of a personal calendar associated with the responding user.

### TECHNICAL FIELD

The present disclosure relates in general to network-based communications, and in particular, to platforms, tools and methods to implement social calendaring functionality within a chat-based communication environment.

### BACKGROUND

Chat-based communication or instant messaging platforms have become increasingly popular avenues for electronic communication, particularly given the rise in dominance of mobile computing and social networking. Popular consumer-facing examples include WeChat, Facebook Messenger, and WhatsApp. Chat apps have also become popular for enterprise communications, including platforms such as Slack and HipChat. Such platforms may provide a flexible and efficient mechanism for real-time communications.

WeChat, in particular, has become a globally-popular messaging app, with over a billion accounts created worldwide and hundreds of millions of active users. WeChat users use the app for a wide variety of interactions and communications, including both personal communications with friends and family, as well as work communications with colleagues, customers and clients.

Many users rely on chat apps such as WeChat as their primary mode of electronic communication with others, including use of the app to communicate with others about scheduling meetings and appointments. However, many chat apps such as WeChat have little or no integrated calendaring functionality. Therefore, meetings and appointments scheduled via chat often require users to rely on memory to attend the scheduled event, or engage on cumbersome entry of events into separate calendar apps.

In some cases, a chat platform may implement some integration with calendaring, such as enabling transmission of iCal or vCal files that may be imported into a separate calendar app. However, such calendaring techniques are of limited value in a chat-focused environment. Traditional calendaring applications utilize email addresses to configure appointments with multiple participants, with appointment acceptance, rejection or modification requests transmitted via email. But in a chat-based environment such as WeChat, groups of individuals may communicate and coordinate events without even knowing one another's email addresses. Therefore, transmitted iCal or vCal appointments provide limited utility and fail to provide a mechanism for effective interaction amongst participants.

In light of the above, it may be desirable to provide social calendaring functionality that interoperates seamlessly and efficiently with one or more chat applications, while requiring little or no custom back end integration with the chat platform. These and other such methods and apparatuses are described further hereinbelow.

### SUMMARY

In accordance with some embodiments, social calendaring functionality can be implemented by a web app using a messaging platform for interaction amongst users. Calendar invitations may be shared as URLs transmitted via a host messaging platform. A calendaring server can query invitee information from the messaging platform, such as via API. Photos, videos and other content can be uploaded and associated with calendar appointments to provide social sharing amongst appointment invitees. Details of these and other aspects of the disclosed embodiments are described in further detail herein.

### BRIEF DESCRIPTION OF THE DRAWINGS

FIG. 1 is a schematic block diagram of a computing environment that may be used in the implementation of some embodiments.

FIG. 2 is a schematic block diagram of a mobile device that can serve as a user device.

FIG. 3 is a process for creating and sharing a calendar appointment.

FIG. 4 is a user device display providing a calendar app hook.

FIG. 5 is a calendar appointment user device display.

FIG. 6 is a user device display for initiating sharing of a calendar appointment via a messaging app.

FIG. 7 is a user device display for selecting a calendar appointment invitee via a messaging app recipient display.

FIG. 8 is a user device display for sending a calendar event via a messaging platform.

FIG. 9 is a process for receiving a calendar event invitation via a messaging platform.

FIG. 10 is a user device messaging app display conveying a calendar appointment invitation.

FIG. 11 is a user device display of a calendar event.

FIG. 12 is a schematic block diagram of multiple user calendars with referenced group events.

FIG. 13 is a user device display of a calendar view.

FIG. 14 is a user device display of a calendar event with user content sharing mechanisms.

### DETAILED DESCRIPTION OF THE DRAWINGS

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Computing Environment

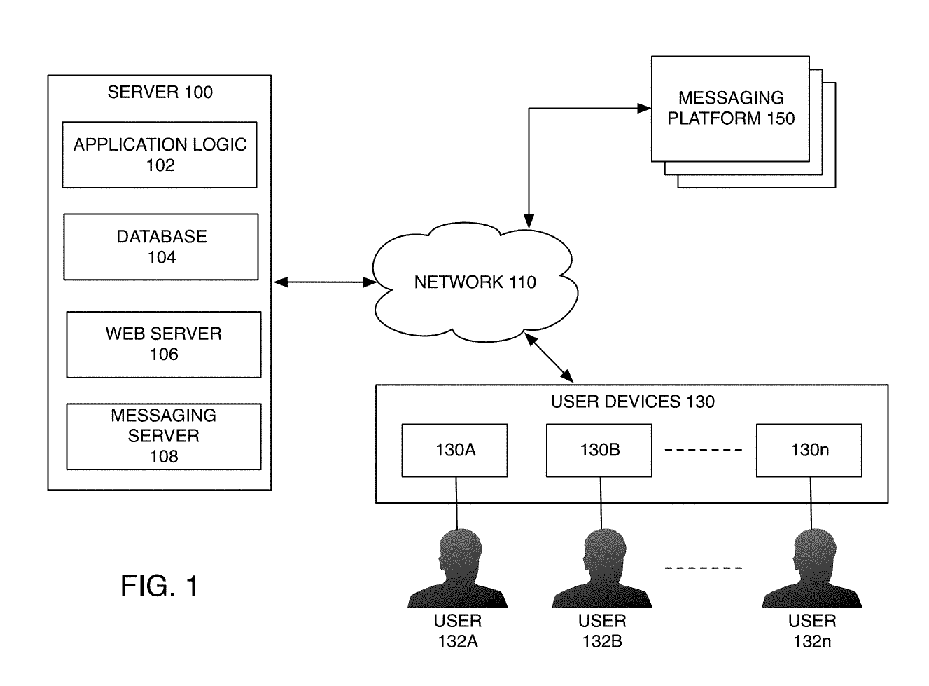

FIG. 1 is schematic block diagram of a computing environment that may be effectively utilized to implement certain embodiments of the systems and methods described herein. Server 100 communicates, inter alia, via computer network 110, which may include the Internet, with user devices 130 (which may include, without limitation: smartphones, tablet computers, laptop computers, desktop computers, smart glasses, smart watches, smart appliances and other mobile or installed electronic devices featuring microprocessors, user interface mechanisms and networked data communications capabilities). In the embodiment of FIG. 1, user devices 130 are referred to individually as user devices 130A through 130n, each associated with a user 132A through 132n. Server 100 and user devices 130 further communicate with one or more messaging platforms 150, which may include, e.g., WeChat.

Server 100 implements application logic 102, and operates to store information within, and retrieve information from, database 104. The term “database” is used herein broadly to refer to a store of data, whether structured or not, including without limitation relational databases and document databases. Web server 106 hosts one or more Internet web sites enabling outside user interaction with, amongst other things, application logic 102 and database 104. Messaging server 108 enables electronic messaging, such as email, SMS and/or MMS communications, and platform-specific instant messaging protocols that may be implemented by, e.g., an Application Programming Interface (API) implemented by one or more of messaging platforms 150.

While depicted in the schematic block diagram of FIG. 1 as a block element with specific sub-elements, as known in the art of modern web applications and network services, server 100 may be implemented in a variety of ways, including via distributed hardware and software resources and using any of multiple different software stacks. Server 100 may include a variety of physical, functional and/or logical components such as one or more each of web servers, application servers, database servers, email servers, storage servers, SMS or other instant messaging servers, and the like. That said, implementations of server 100, client devices 130, and messaging platforms 150 will typically include at some level one or more physical computers having one or more microprocessors and digital memory for, inter alia, storing instructions which, when executed by the processor, cause the computers to perform methods and operations described herein.

Messaging platforms 150 may include one or more social media and/or online communication platforms, such as (without limitation) WeChat™, WhatsApp™, SnapChat™, Instagram™ and/or Twitter™. Interactions with messaging platforms 150 may take place via APIs, messaging protocols, intra-device application handoff, or other mechanisms, as is known in the art.

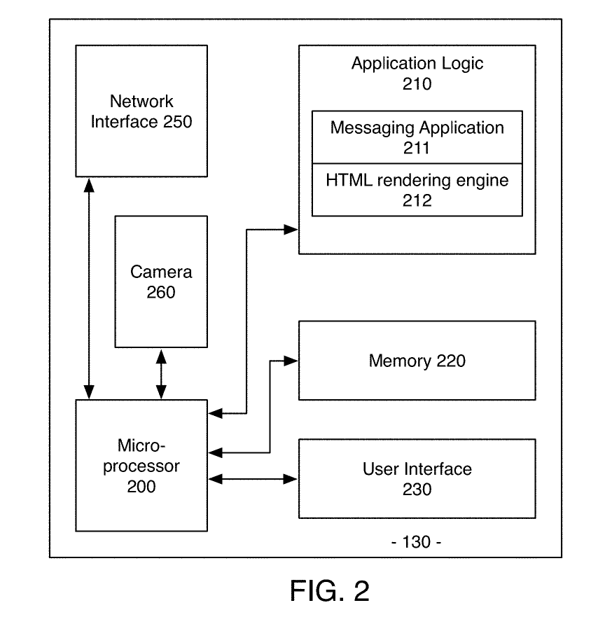

FIG. 2 is a schematic block diagram of an exemplary mobile computing device that may be used as user device 130. User device 130 includes microprocessor-based controller 200, application logic 210, digital memory 220, user interface components 230, network interface 250, and digital camera module 260. User interface components 230 may include a touch-sensitive display screen, as is typical of a smartphone or tablet computer. Microprocessor 200 implements application logic 210 to, amongst other things, interact with user interface components 230, camera 260 and network interface 250, and to perform various functions described further elsewhere herein.

Social Calendaring within a Messaging Environment

Instant messaging applications, such as WeChat, may be used for implementation of social calendaring functionality, even with little or no platform-level integration. Core calendaring functions may be implemented via a web application, particularly a mobile web app. The messaging platform may then be utilized to, e.g., transmit notifications, manage users and enable user interaction with the calendar app within the messaging environment via, e.g., selection of URLs transmitted via instant message. The web app may utilize graphic design elements consistently with the associated messaging app to present a relatively seamless user interface to users. In some embodiments, the calendaring web app may be rendered by an HTML viewer implemented within the messaging app; in other embodiments, hyperlinks may enable dynamic switching between a messaging app and web browser application.

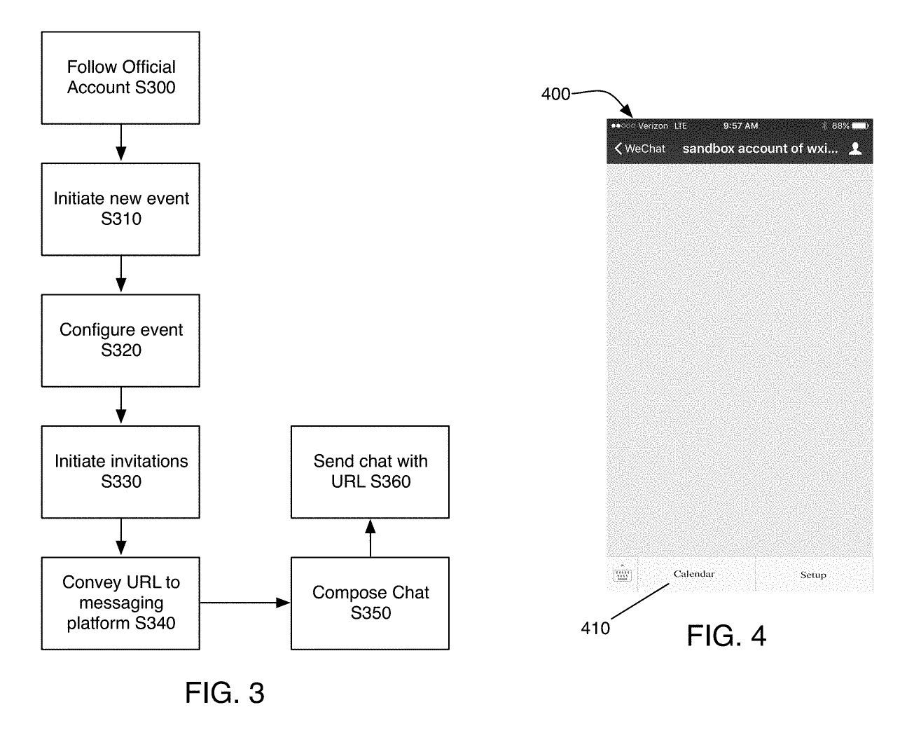

FIG. 3 illustrates an exemplary process for generating a calendar event and transmitting it via a chat messaging system, such as the WhatApp messaging platform. In step S300, an initial user 132A utilizes user device 130A, having the WeChat messaging application installed thereon for interaction with WeChat messaging platform 150, to follow an Official Account associated with a social calendaring service implemented by server 100. Within the WeChat platform, following an Official Account associated with server 100 enables certain API-implemented interactions between server 100 and messaging platform 150, with respect to the following-user's account on messaging platform 150. Examples of interactions enabled by a messaging platform API may include, e.g., disclosure of contacts and connections maintained by the user's WeChat account, passing of information from server 100 to messaging platform 150, and enabling server 100 to initiate messaging communications via a follower's user account on messaging platform 150. While certain embodiments implemented using the WeChat platform may utilize a mechanism of following an Official Account to facilitate interactions between server 100 and a user's account on messaging platform 150, it is contemplated and understood that in other embodiments, such as social calendar embodiments interacting with other messaging platforms, different and/or additional mechanisms may be utilized to facilitate system interactions between the messaging platform and calendar server.

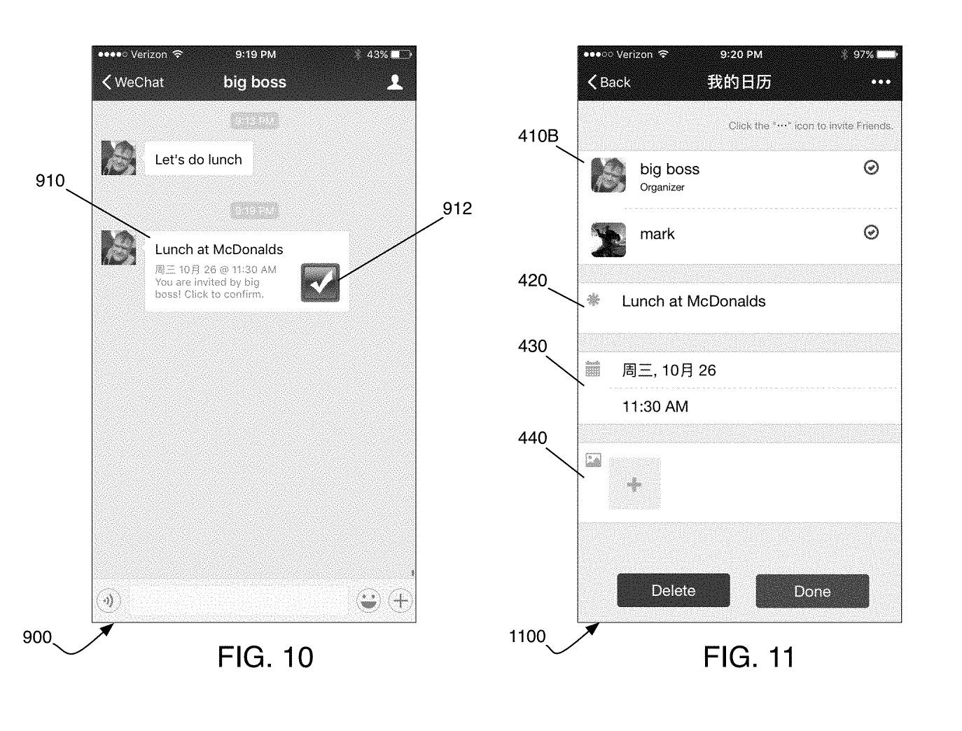

In step S310, a first user 132A utilizes user device 130A to initiate the creation of a new calendar event. The calendar web app can be initiated by one or more hooks within the user device application logic. For example, in an embodiment providing calendar service integrated with the WeChat messaging platform, where users follow an Official Account associated with the calendar service, a calendar hook may be provided from the Official Account page. FIG. 4 illustrates an exemplary user interface 400 for such a calendar hook, with Calendar button 410 hyperlinked to the calendar web app. Calendar hooks may also be provided from chat messages, e.g. messages in which a hyperlink is included. (See, e.g., discussion below concerning the embodiment of FIG. 10, with chat message 1010 and calendar hyperlink 1012.) A calendar hook may also be implemented by direct navigation to a predetermined URL using a web browser application; this technique may be effective particularly when used in combination with chat or social communication applications that allow single-sign on functionality whereby the user's social messaging credentials may be used to both identify the user and authenticate the calendar application with the social messaging application. These and other mechanisms for starting the calendar service may be provided.

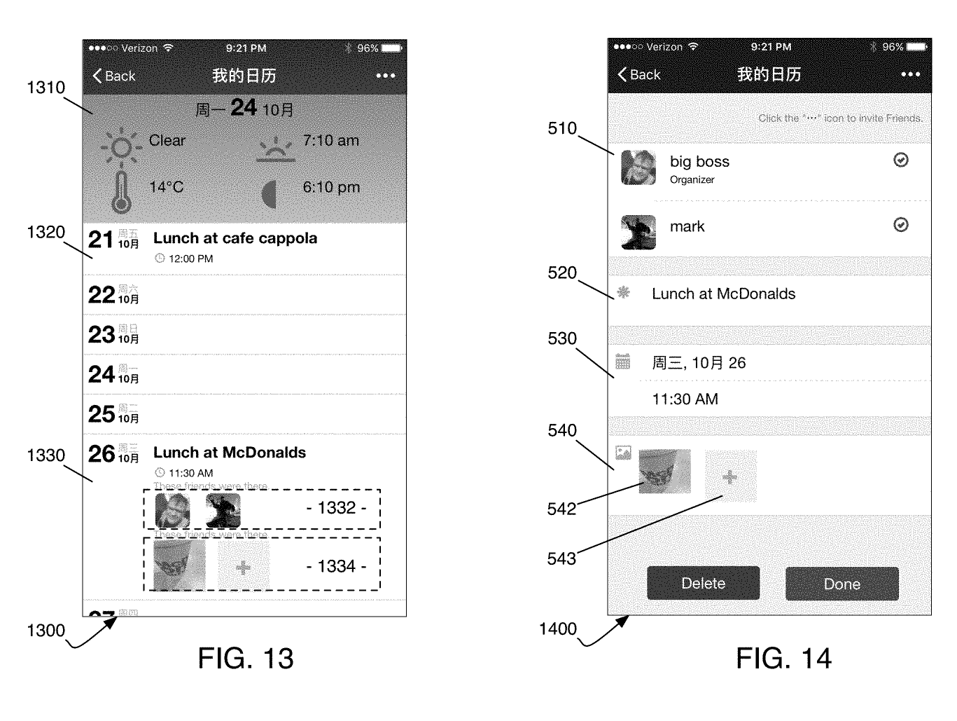

Once the calendar service is initiated on the user device, a user interface element may be selected to initiate creation of a new calendar event. In some embodiments, a new event may be created by selecting a location associated with a desired date and/or time in a calendar view, such as the timeline view of FIG. 13.

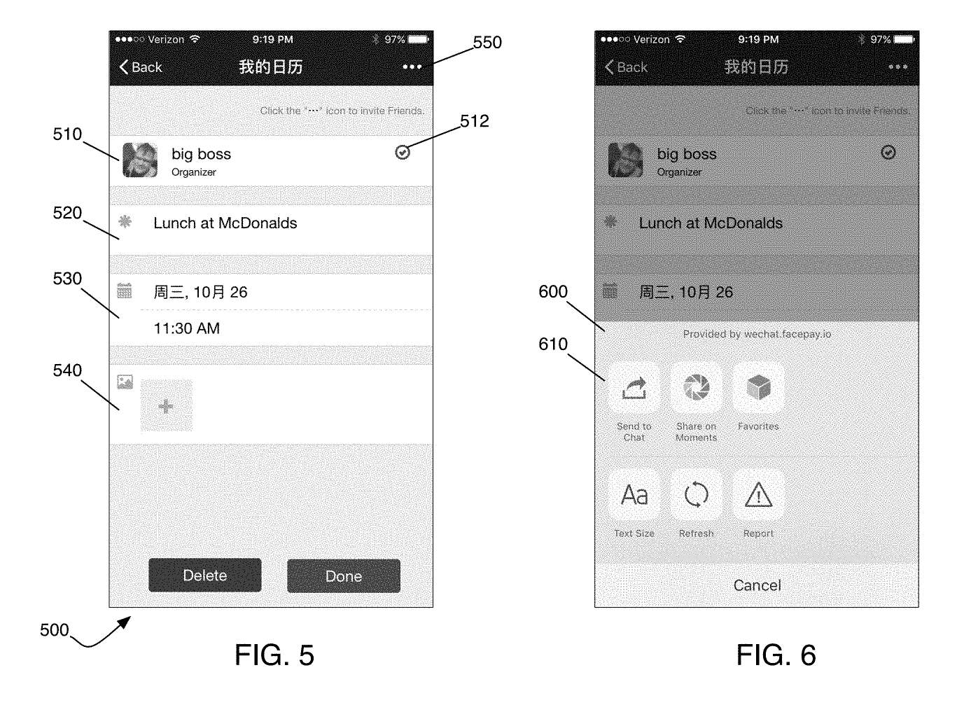

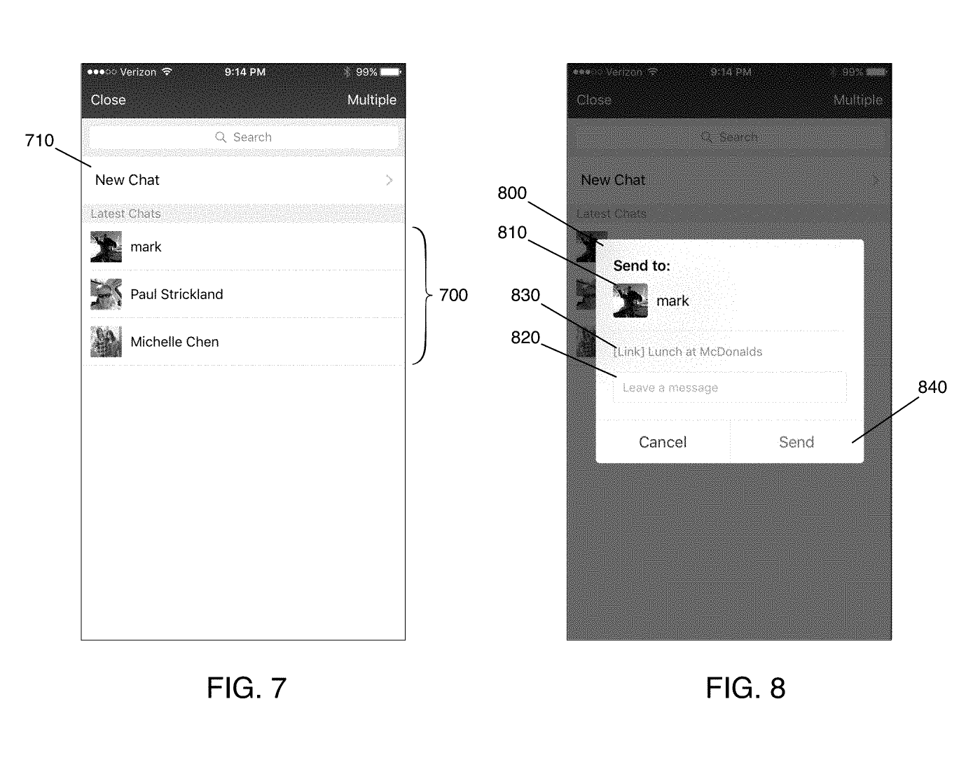

Once the creation of a new event has been initiated, server 100 interacts with user device 130A in order to render an event configuration user interface screen on device UI 230, which may be used to configure the event (step S320). FIG. 5 illustrates an exemplary embodiment of a new event configuration screen 500. New event configuration screen 500 is implemented via a web app, i.e. via HTML downloaded from server 100 and rendered on user device 130A. Preferably, screen 500 is rendered within user-side messaging app 211 via interaction with a local HTML rendering engine 212, thereby providing users with relatively seamless interaction between web app-based calendar screens and associated messaging application 211.

Region 510 indicates individuals associated with the event; at the process stage illustrated in FIG. 4, the only event invitee is the event organizer. Icon 512 provides an indicium indicative of the invitee's status relative to the invitation; e.g., in the embodiment of FIG. 5, the illustrated green check indicium may indicate the user's acceptance of the event. Other invitee statuses may be indicating by alternative indicia, including, without limitation, statuses such as: invited without response, invited but declined, or uncertain.

Region 520 indicates an event title or subject, which may be configured by the originating user. Region 530 provides for specification by the originating user of metadata to be associated with the event. Examples of metadata that may be provided in region 530 include, without limitation, a date and time for the event, a geographic location of the event, or a business or location name associated with the event. Region 540 provides indicia of user-contributed content items associated with the event, discussed further hereinbelow. These and other calendar item content fields may be displayed in an event view screen.

In step S330, user 132A may invite other users to the calendar event via messaging platform 150. In the embodiment of FIG. 5, the user may select sharing indicium 550 to initiate adding other users to the illustrated event. In response to selection of sharing indicium 550, the display of FIG. 6 is rendered, with modal dialog 600 rendered over the event configuration screen. Modal 600 presents options for interaction between messaging app 211 and the social calendar web app rendered on device 130A by HTML rendering engine 212. The user may then select, e.g., Send to Chat button 610 in order to utilize messaging platform 150 (in this embodiment, WeChat) to invite other users of messaging platform 150 to the event.

Upon selection of Send to Chat button 610, the web app conveys information associated with the event configured on screen 500, to local messaging application 211, in the form of a URL (step S340). Device 130A (executing messaging app 211) then renders display 700, through which user 132A can select a chat or chat channel via which the calendar invitation may be conveyed. In particular, user 132A may select a recent contact 700 with whom user 132A has recently messages, or may initiate a new chat by selecting region 710 and subsequently identifying a recipient. Information associated with selected users is made available from messaging platform 150 to server 100 (e.g. user ID, user name, or other identifying information) such that server 100 may track the individuals to whom the calendar event was transmitted.

Once a calendar event invitee is selected within local messaging app 211, a chat composition dialog is displayed (step S350), such as dialog 800 in FIG. 8. Dialog 800 include chat recipient designator 810, chat message area 820, and link indicium 830. Link indicium 830 indicates that messaging app 211 is transmitting, with the chat message, a URL associated with the calendar event configured in step S320. The URL is generated by server 100 (whether directly or via interaction with a web app running locally within HTML engine 212) and passed to messaging app 211 from calendar server 100 via the locally-rendered web app in step S340. User 132A may further include a message, entered in message entry field 820. The message entered in field 820 may be used to explain the nature of the event for which invitation is attached, and to encourage the recipient to respond to the invitation. Upon completion of the message, user 132A may select Send button 840 in order to transmit the chat message via messaging platform 150 to the user indicated (step S360), e.g. user 132B utilizing user device 130B.

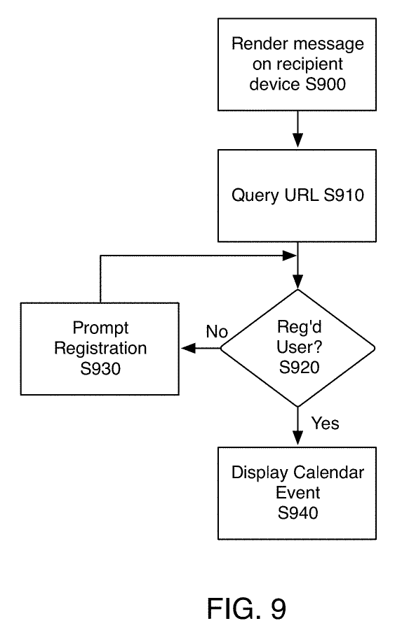

FIG. 9 illustrates a process for receiving and responding to a calendar invitation transmitted via a messaging app such as WeChat. In step S900, messaging app 211 operating on recipient user device 1308 may receive the chat message and render an alert or other display thereon in order to notify recipient user 132B of the chat message conveying the calendar invitation. FIG. 10 illustrates a chat display 1000 rendered on device 130B. Message 1010 includes URL indicium 1012, associated with the calendar event-specific URL generated in step S340 and transmitted in step S360. Selection of URL indicium 1012 causes messaging app 211 to pass the URL to HTML rendering engine 212, which in turn queries server 100 an initiates local operation of the calendar web app by HTML rendering engine 212 (step S910).

The URL query in step S910 preferably passes information associated with user 132B and/or the account of user 132B on messaging platform 150, to server 100. Server 100 may in turn utilize that information to identify the querying user. In some embodiments, server 100 may utilize the query of step S910 in order to determine whether user 1328 has previously registered its account with the social calendaring service implemented via server 100 (step S920). For example, in embodiments in which WeChat is the messaging platform, a user ID associated with user 132B may be used to query whether user 1328 is also a follower of the Official Account associated with the social calendaring service. If not, the user is prompted to register (step S930), such as via display of an HTML notification to follow an Official Account associated with the calendaring service. The local web app may then await user registration. Such user registration, such as following an Official Account associated with server 100 on WeChat, may be desirable to facilitate ready transfer of information associated with the user to server 100.

If user 132B is registered (e.g. if user 132B follows a calendar service Official Account within an exemplary embodiment using a WeChat messaging platform), then server 100 operates to render a calendar appointment view display on device 130B (step S940). FIG. 11 illustrates a calendar appointment display 1100, providing a view analogous to that of FIG. 5, upon acceptance by recipient 132B. Region 510 now indicates two individuals associated with the event: event originator 132A and recipient 1328. Regions 520 and 530 continue to convey event title and time/date information to the viewer, with region 540 remaining available for user-originated content associated with the event.

Upon selection of URL indicium 1012 and corresponding acceptance of the calendar event, users 132A and 132B both have the calendar event associated with their respective accounts on server 100. However, rather than maintaining independent calendar databases for each user, with each event having a record in each user's associated calendar database, in some embodiments, it may be desirable to utilize a referenced calendar event methodology. Data associated with each calendar event is stored in a primary database event record, associated with the originating user. After the event is accepted by other users (e.g. invitees), server 100 associates each accepting user with a pointer directed to the originating user's primary event record. Such an approach may be particularly advantageous for social-based calendaring systems, in which users contribute photos, video recordings or other data with the event.

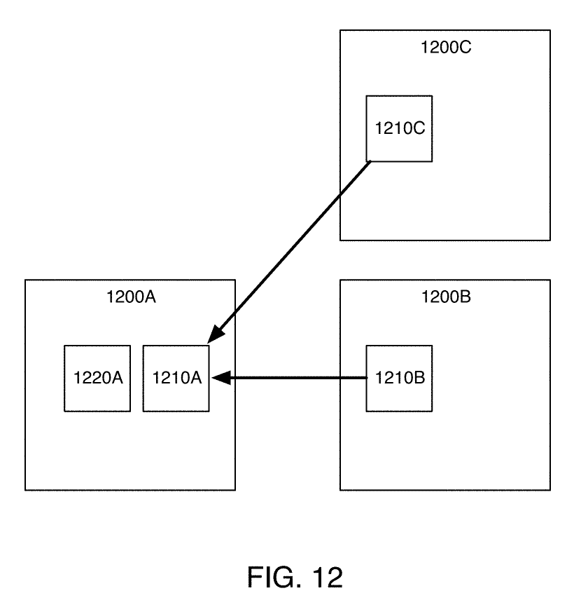

An example is illustrated schematically in FIG. 12. Calendar data structure 1200A is associated with an account for user 132A, while calendar data structure 1200B is associated with an account for user 132B. A first calendar event originated by user 132A is represented by primary event record 1210A. Upon accepting an invitation to the event, as described above, pointer record 12108 is stored within calendar data structure 1200B, referencing primary event record 1210A. If a third user is associated with calendar data structure 1200C and subsequently accepts an invitation to the same event, pointer record 1210C is stored within calendar data structure 1200C, also referencing primary event record 1210A. Thus, views of a user's calendar may be rendered by displaying events stored directly within the associated calendar data structure, as well as event records referenced directly from the associated calendar data structure. For sake of illustration, calendar events may also be created by a user without inviting others, in which case a primary event record is stored within the user's calendar data structure, without incoming references from other users. Event 1220A is illustrative of such an event.

After a user accepts a calendar event, various calendar views may be presented to the user for personal planning and organization, aggregating all events with which the user is associated. FIG. 13 illustrates one such view, providing a scrolling timeline view. A scrolling timeline view may be particularly desirable in some social calendaring applications. For example, some users may be accustomed to scrolling feed presentation of mobile social media apps, but unaccustomed to use of electronic calendar applications with traditional daily/weekly/monthly views. A scrolling timeline view may be particularly beneficial for such users to effectively navigate. The scrolling timeline view may also provide valuable context for users, viewing events in context with other events with which they are temporally proximate.

In the embodiment of FIG. 13, display 1300 includes current day region 1310, which provides information about the current day (such as weather, time of sunrise and time of sunset). Below current day region 1310 are per-day calendar blocks displaying any calendar events associated with each day. For example, region 1320 is associated with a day in the past, and indicates a lunch appointment that had been set for that day. Region 1330 indicates a date two days after the current date, and indicates an upcoming lunch appointment. Invitee region 1332 provides image indicia of the individuals associated with that appointment, while content region 1334 provides thumbnails of user-contributed content items associated with the appointment (described further hereinbelow). Display 1300 may be scrolled upwards and downwards to view dates further back and further forward in time, respectively. These and other calendar views can be presented to a user on device 130 via interaction with server 100 and messaging platform 150.

By providing integrations between a group calendaring function and a messaging platform, the group calendaring function can also be readily utilized as a social networking and/or sharing tool. For example, individuals invited to a calendar event for a dinner or party may wish to share and/or store their respective photos of the event, via the calendar appointment. Other types of user-generated content that may be shared or stored in association with the event include documents, forms, surveys or polls, or the like. Such a sharing operation may provide for seamless content distribution amongst interested parties, particularly, the people who attended the event. This content sharing mechanism may also be useful in memorializing events, providing historical content that is easily discoverable based on the user's prior calendar appointments.

FIG. 14 illustrates a calendar appointment display 1400, analogous to that of FIG. 5, for an appointment via which user-contributed content has been shared. Image indicium 542 provides a thumbnail of a photo has been uploaded to the calendar appointment. Indicium 542 can be selected by any user viewing appointment display 1400, for further interaction with an associated image (such as full-display rendering of the image, saving of the image to a local device, and/or forwarding of the image). Plus indicium 543 can be selected by any user viewing appointment display 1400, in order to contribute additional content to the appointment. Selection of indicium 543 may initiate functionality implemented natively by mobile device 130 in order to upload content (such as photos or video) from local storage 220 to server 100. As additional user-contributed content is associated with the calendar appointment of display 1400, additional thumbnails or other indicia may be displayed within content region 540.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or any appended claims.

1. A method for a network-connected server to implement an electronic calendar for use with a plurality of user devices, the method comprising:
receiving initiation of the calendar event via selection by an initiating user device of a URL associated with the server;
presenting, by the server to the initiating user device, a web-based user interface enabling specification of event parameters, the event parameters comprising a sharing indicium for specifying one or more event invitees, the one or more event invitees each associated with a user account on one or more chat messaging platforms;
transmitting, to the one or more event invitees, a chat message via a chat message platform associated with each invitee, the chat message comprising an event URL associated with the server;
receiving, by the server, a query to the event URL by a responding one of said event invitees; and
presenting, by the server, to the responding event invitee, a web-based user interface rendering information descriptive of the event.
